(19) United States
(12) Patent Application Publication
(10) Pub. No.: US 2025/0221471 A1
(43) Pub. Date: Jul. 10, 2025

(54) SUPPORT GARMENT

(71) Applicant: NIKE, Inc., Beaverton, OR (US)

(72) Inventors: Andrew L. DePew, Portland, OR (US); Iustinia Koshkaroff, Portland, OR (US); Ariana S. Levitt, Portland, OR (US); Yuan Mu, Portland, OR (US)

(73) Assignee: NIKE, Inc., Beaverton, OR (US)

(21) Appl. No.: 19/008,298

(22) Filed: Jan. 2, 2025

Related U.S. Application Data
(60) Provisional application No. 63/618,071, filed on Jan. 5, 2024.

(51) Int. Cl. A41C 3/12; B29C 64/118; B29K 75/00; B29L 31/48; B33Y 10/00; B33Y 80/00

(52) U.S. Cl. CPC A41C 3/12; B29C 64/118; B33Y 10/00; B33Y 80/00; B29K 2075/00; B29K 2995/0025; B29L 2031/4885

(57) ABSTRACT

A method of 3D printing a garment can include 3D printing a first filament layer extending in a first direction, and 3D printing a second filament layer over the first filament layer. The second filament layer can extend in a second direction different than the first direction such that the first and second filament layers overlap one another at a plurality of contact points and collectively define a plurality of open cells.

### CROSS REFERENCE TO RELATED APPLICATION

This application claims the benefit of U.S. Provisional Application No. 63/618,071, filed Jan. 5, 2024. The prior application is incorporated herein by reference in its entirety.

### FIELD

This disclosure relates generally to support garments and more particularly to support garments comprising one or more zones having different characteristics and methods for making the same.

### BACKGROUND

A support garment is configured for supporting the wearer's chest and back and typically includes a chest or cup region, a band region, a back region, and one or more strap regions. Improvements in the design and/or functioning of support garments are always desirable.

Printing systems can be used to print 2D structures or layers of ink as well as 3D structures formed from various kinds of 3D printing materials. 3D printing of garments allows for greater garment-making efficiency, less overall waste, unitary material construction, which lends to increased sustainability and potential for recyclability at the end of garment life, and greater customizability and tuneability for increased support, fit, and comfort.

### BRIEF DESCRIPTION OF THE DRAWINGS

FIG. 1 illustrates a support garment, according to one example, shown in a flattened configuration.

FIG. 2 illustrates a portion of the support garment of FIG. 1, shown schematically to illustrate the amount and direction of stretch.

FIG. 3 illustrates a portion of the support garment of FIG. 1 showing a map of the vertical stretch.

FIG. 4 illustrates a portion of the support garment of FIG. 1 showing a map of the horizontal stretch.

FIG. 5 is another illustration of the support garment of FIG. 1.

FIG. 6 is an enlarged partial cross-sectional view of the material of the support garment of FIG. 1.

FIG. 7 is a partial view of the strap region of the support garment of FIG. 1.

FIG. 8 illustrates the first and third layers of the support garment of FIG. 1.

FIG. 9 illustrates the second and fourth layers of the support garment of FIG. 1.

FIG. 10 illustrates various exemplary auxetic patterns.

FIG. 11 illustrates a map of the support garment of FIG. 1 illustrating the amount of stretch.

FIG. 12 illustrates another example of a support garment, shown in a flattened configuration.

FIG. 13 illustrates another example of a support garment, shown in a flattened configuration.

FIG. 14 illustrates a fastening mechanism for a support garment, according to one example.

FIGS. 15-17 illustrate an example of a support garment.

FIGS. 18-21 illustrate an example of a support garment.

FIGS. 22-25 illustrates various other examples of support garments, shown in a flattened configuration.

FIG. 26 illustrates the support garment of FIG. 1 showing close-ups of specific cells.

FIG. 27 illustrates the support garment of FIG. 1 illustrating the amount and direction of stretch bias when the garment is in the relaxed configuration.

FIG. 28 is a flow chart depicting an exemplary method of making a support garment.

### DETAILED DESCRIPTION

The garments described herein, and individual components thereof, should not be construed as being limited to the particular uses described herein in any way. Instead, this disclosure is directed toward all novel and non-obvious features and aspects of the various disclosed embodiments, alone and in various combinations and sub-combinations with one another. For example, any features or aspects of the disclosed embodiments can be used in various combinations and sub-combinations with one another, as will be recognized by an ordinarily skilled artisan in the relevant fields in view of the information disclosed herein. In addition, the disclosed garments, methods, and components thereof are not limited to any specific aspect or feature or combinations thereof, nor do the disclosed garments and methods require that any one or more specific advantages be present or problems be solved.

As used in this application, the singular forms “a,” “an,” and “the” include the plural forms unless the context clearly dictates otherwise. Additionally, the term “includes” means “comprises.” Further, the terms “coupled” or “secured” encompass mechanical and chemical couplings, as well as other practical ways of coupling or linking items together, and do not exclude the presence of intermediate elements between the coupled items unless otherwise indicated, such as by referring to elements, or surfaces thereof, being “directly” coupled or secured. Furthermore, as used herein, the term “and/or” means any one item or combination of items in the phrase.

As used herein, the term “exemplary” means serving as a non-limiting example, instance, or illustration. As used herein, the terms “e.g.,” and “for example,” introduce a list of one or more non-limiting embodiments, examples, instances, and/or illustrations. As used herein, “e.g.” means “for example,” and “i.e.” means “that is.”

As used herein, the directional terms (e.g., “upper” and “lower”) generally correspond to the orientation of a garment as it is configured to be worn by a wearer. For example, an “upward-facing surface” and/or an “upper surface” refers to the surface oriented in the “superior” anatomical direction (i.e., toward the head of a wearer) when the garment is being worn by the wearer. Similarly, the directional terms “downward-facing surface” and/or “lower surface” refers to the surface oriented in the “inferior” anatomical direction (i.e., toward the ground and away from the head of the wearer). “Front” means “anterior” (e.g., towards the toes) and “rear” means “posterior” (e.g., towards the heel). “Medial” means “toward the midline of the body” and “lateral” means “away from the midline of the body.”

As used herein, the terms “fixedly attached” and “fixedly coupled” refer to two components joined in a manner such that the components may not be readily separated from one another without destroying and/or damaging one or both of the components. Exemplary modalities of fixed attachment may include joining with permanent adhesive, stitches, welding or other thermal bonding, and/or other joining techniques. In addition, two components may be “fixedly attached” or “fixedly coupled” by virtue of being integrally formed, for example, in a molding process.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the detailed description, abstract, and drawings.

Described herein are examples of various support garments including regions or zones designed to have different properties, such as different moduli of vertical and horizontal stretch. The regions can be positioned to provide a desired level of support or “lockout” in certain areas (also referred to herein as “regions”) of the support garment, while allowing for greater stretch in other regions to allow the garment to be pulled over the wearer's head and sit flush against the wearer's body where desired.

The garment can also comprise a plurality of open cells, which can be oriented differently depending on the respective zone within the garment. The orientation of the open cells can result in the cells having different directions of stretch bias. This stretch bias provides the desired amount of lockout or stretch to the garment, allowing for increased support, fit, and/or comfort to the wearer.

In some examples, the garment can be 3D printed using various three-dimensional printing systems and methods associated with technologies including fused deposition modeling (FDM), electron beam freeform fabrication (EBF), selective laser sintering (SLS) as well as other kinds of three-dimensional printing technologies. As such, the garment can be constructed from a plurality of layers that are printed on top of one another with gaps between them to enable directional freedom.

3D printing also allows the garment to be customized for the wearer's body. The regions of lockout and stretch can be customized to have a specific amount of support and/or stretch based on the wearer's body and/or fit preference. For example, a potential wearer or customer can be measured or scanned in-store. The support garment can then be custom printed according to their specific measurements and/or fit or color preferences.

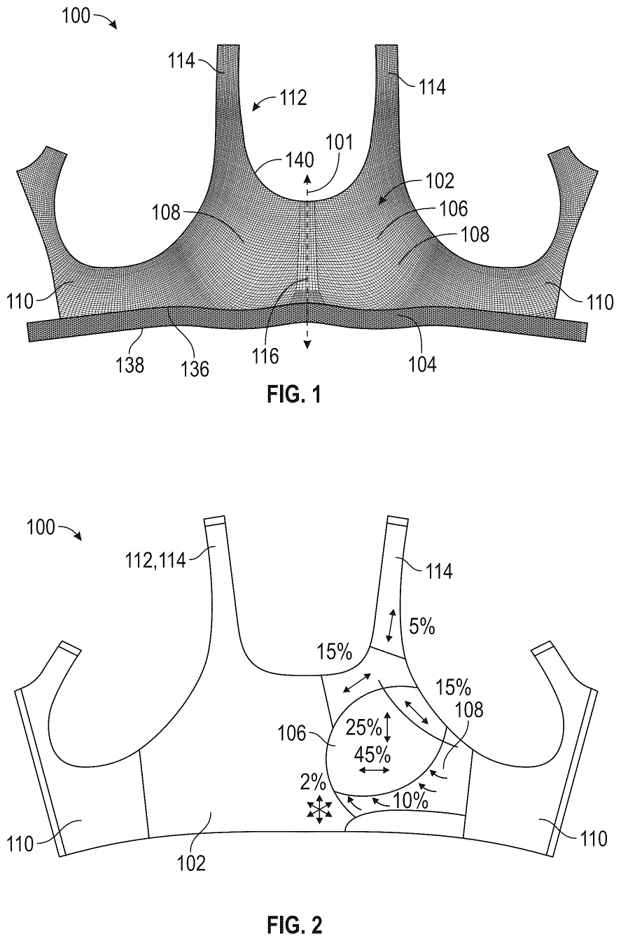

Referring to the figures, FIGS. 1-9 illustrate an exemplary support garment 100. Though the garment 100 is shown in a flat configuration, it should be understood that portions of the garment can be coupled together to form a three-dimensional, wearable garment. In some examples, such as those shown in FIGS. 1-9, the support garment 100 can be an upper garment worn on a wearer's upper torso, for example, a bra or cropped shirt. In other examples, the support garment can be worn on a wearer's lower body, such as, for example, underwear, shorts, leggings, etc. In still other examples, the support garment can be a full-torso or full-body garment such as a leotard, unitard, or swimwear.

Referring to FIG. 1, the support garment 100 comprises a main body 102 and a band 104 (also referred to as a “band region”). The main body 102 comprises one or more regions, for example, a cup region 106 comprising one or more cups 108, a back region 110, and a strap region 112 comprising one or more straps 114. In some examples, the cup region 106 can further comprise a center front region 116 disposed between first and second cups 108 and configured to be disposed over a wearer's breastbone. The garment 100 is bilaterally symmetrical about median axis 101.

In some examples, the entirety of the garment 100 comprises a homogenous material. That is, the entire garment can be formed of the same material (e.g., a selected polymer) but different portions of the garment can comprise different densities, moduli of elasticity, hardness (durometer), etc. In some examples, the material comprises a polymer, for example, thermoplastic polyurethane (TPU), such as TPU-70A, TPU-60A, and/or TPU-85A. In other examples, the material can comprise polyurethane (PU).

Forming the garment from a homogenous material as described above, can advantageously lead to improved sustainability and/or recyclability due to reduced waste (e.g., there is no cutting of the garment from a larger piece of material). In some examples, the garment itself can be comprised of recycled material and/or can be recycled at the end of the garment's life.

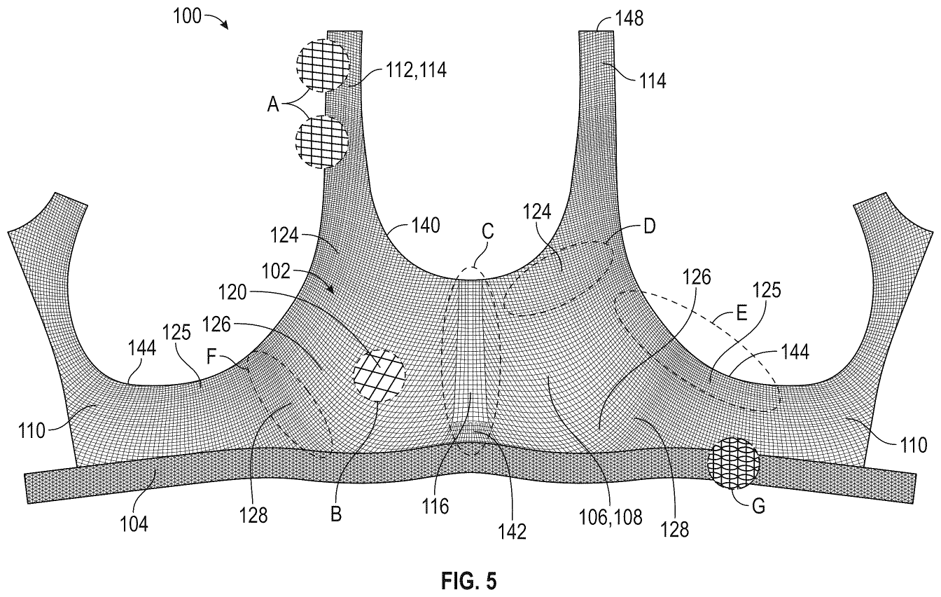

The garment is movable between a relaxed configuration, for example, when not being worn, a stretched configuration, for example, when being donned or doffed, and a use configuration (also referred to as a “partially stretched” configuration), for example, when being worn by the wearer. Referring still to FIG. 1, the garment 100 can comprise a mesh material including a plurality of open cells 120 (see e.g., FIG. 5). The mesh material can advantageously provide increased breathability and increased sweat evaporation as well as decreased weight. The shape, orientation, and density of the cells 120 can change depending on the location (i.e., region) in which the cells are disposed in order to provide selected properties (e.g., a desired amount of stretch) in certain regions.

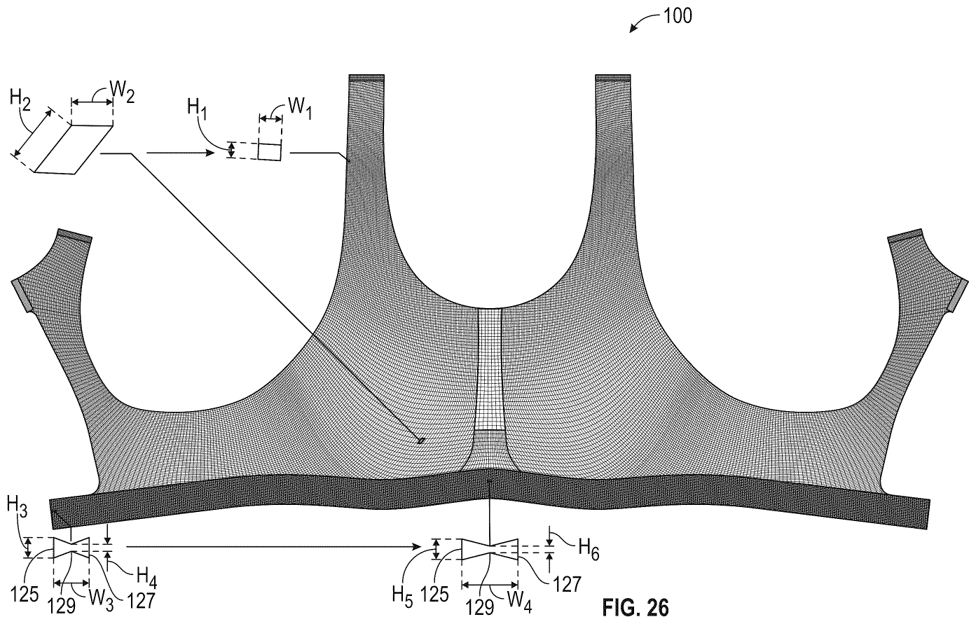

In some examples (see e.g., FIG. 26), when in the relaxed configuration, the smallest of the open cells can have a minimum width W₁ of about 1.2 mm to about 2 mm, about 1.3 mm to about 1.9 mm, about 1.4 mm to about 1.8 mm. In some examples, when in the relaxed configuration, the smallest of the open cells can have a minimum height H₁ of about 0.8 mm to about 1.4 mm, about 0.9 mm to about 1.3 mm, about 1 mm to about 1.2 mm. In some examples, when in the relaxed configuration, the largest of the open cells can have a minimum width W₂ of about 3.0 mm to about 4.0 mm, about 3.2 mm to about 3.8 mm, of about 3.4 mm to about 3.6 mm. In some examples, when in the relaxed configuration, the largest of the open cells can have a minimum height H₂ of about 4.6 mm to about 5.6 mm, about 4.8 mm to about 5.4 mm, of about 5.0 mm to about 5.2 mm.

As shown in FIGS. 2-4, certain regions of the garment 100 can have areas of increased stretch in the vertical and horizontal directions relative to other regions of the garment. FIG. 2 illustrates a general overview of the directions of stretch for specified regions. The percentages refer to the general relative percentage of stretch, with the higher numbers indicating a greater amount of stretch in those regions.

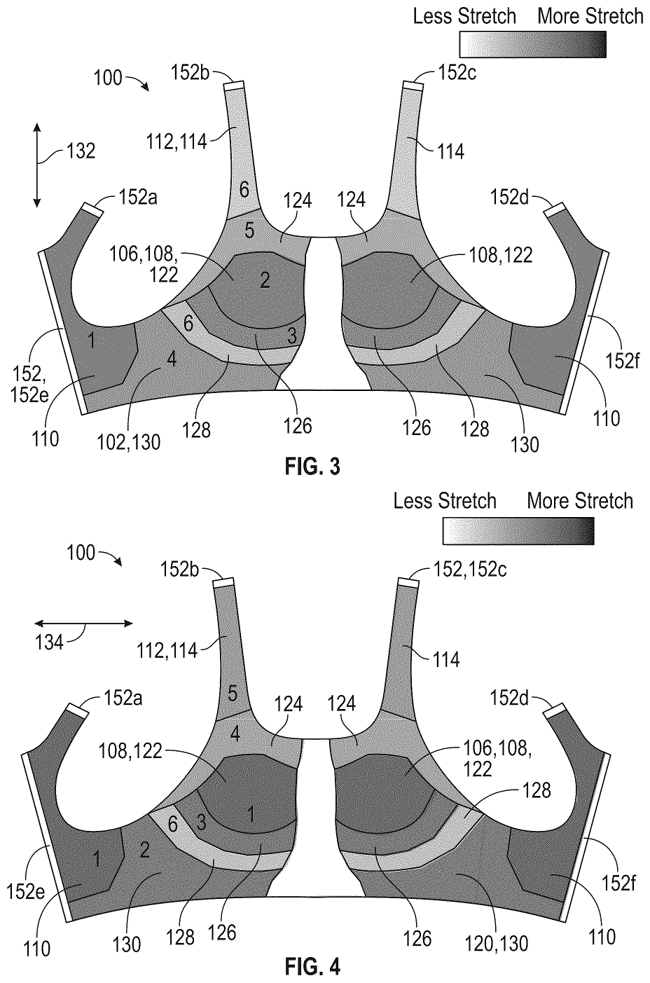

Referring to FIG. 3, each cup 108 can have a central cup region 122, an upper cup region 124, a first lower cup region 126, a second lower cup region 128 (also referred to as a ‘support region’), and a side region 130. The central cup region 122 can be configured to have more stretch in the vertical and horizontal directions (i.e., a lower modulus of elasticity) than the surrounding regions 112, 124, 126, 128, such that it can stretch/deform to contour to the wearer's breasts. The back 110 and side regions 130 can likewise be configured to have more stretch in the vertical and horizontal directions (i.e., a lower modulus of elasticity) than regions 112, 124, 126, 128, which can advantageously allow the user to deform/stretch the garment when putting it on (e.g., by pulling it over their head) and then allow the garment to contour to the wearer's body during wearing.

FIG. 3 also illustrates the relative vertical stretch of each region, the vertical direction being indicated by arrow 132. Generally the amount of stretch in the vertical direction (referred to herein as “vertical stretch”) can proceed from greatest amount of vertical stretch to least amount of vertical stretch in the following order, which is indicated using numbers 1-6 in FIG. 3: (1) back region 110, (2) central cup region 122, (3) first lower cup region 126, (4) side region 130, (5) upper cup region 124, and (6) the strap region 112 and second lower cup region 128, which have substantially the same amount of vertical stretch. That is to say that the back region 110 has a greater amount of vertical stretch than the central cup region 122, the central cup region 122 has a greater amount of vertical stretch than the first lower cup region 126, and so on.

FIG. 4 illustrates the relative horizontal stretch of each region, the horizontal direction being indicated by arrow 134. Generally the amount of stretch in the horizontal direction (referred to herein as “horizontal stretch”) can proceed from greatest amount of horizontal stretch to least amount of horizontal stretch in the following order, which is indicated using numbers 1-6 in FIG. 4: (1) back region 110 and central cup region 122, which have substantially the same amount of horizontal stretch, (2) side region 130, (3) first lower cup region 126, (4) upper cup region 124, (5) strap region 112, and (6) second lower cup region 128. That is to say that both the back region 110 and central cup region 122 have a greater amount of horizontal stretch than the side region 130, the side region 130 has a greater amount of horizontal stretch than the first lower cup region 126, and so on.

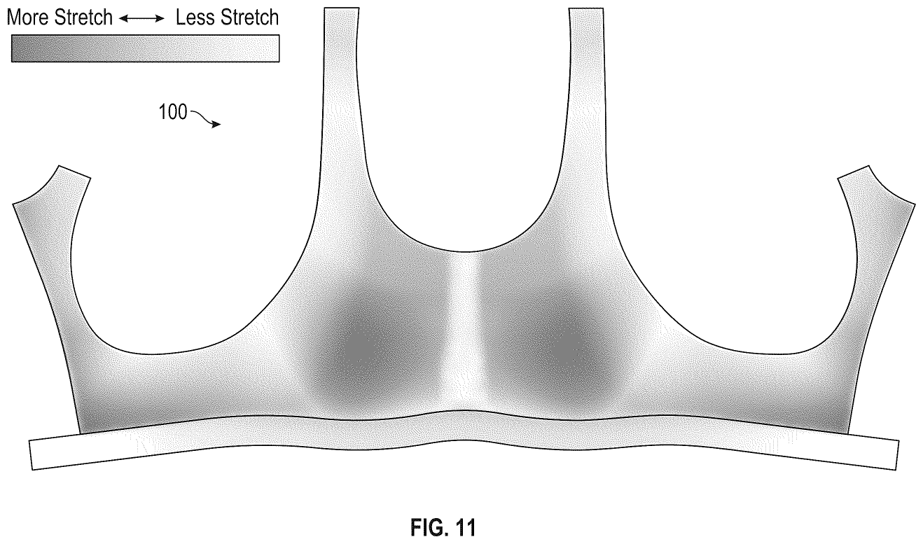

This configuration of vertical and horizontal stretch regions advantageously allows for the most stretch in the cups 108 and back 110, allowing the garment to contour to the wearer's chest. The relatively lesser amount of stretch in the second lower cup region 128 provides support under the wearer's breast area, which can simulate the supportive feeling of underwire in conventional bras. Likewise, the relatively lesser amount of stretch in the strap region 112 can advantageously provide support for the garment during the wearer's movement. While FIGS. 2-4 do not illustrate the band region 104 or center front region 116, it should be understood that a band region 104 and/or center front region 116 can be incorporated as part of any of the garments described herein. FIG. 11 further illustrates the stretch zones of the garment 100 including both the vertical and horizontal stretch.

Referring again to FIG. 1, as mentioned previously, the garment 100 can comprise a band region 104. The band region 104 can be coupled to a bottom edge 136 of the main body 102. The band region 104 provides a high amount of stretch in both the vertical and horizontal directions in order to allow the wearer to don and doff the garment. The band region 104 can further comprise a low modulus of elasticity such that it can easily return to its original shape. This allows the bottom edge 138 of the garment to remain in place when in the use configuration. In some examples, as described in further detail herein, the band region 104 can comprise an auxetic design configured to allow the band region 104 to avoid vertical collapse (i.e., narrowing) when stretched horizontally.

As also mentioned previously, the garment 100 comprises a center front region 116 disposed between the two cups 108. The center front region 116 can be an elongated strip of cells extending from an upper edge 140 of the main body 102 to the lower edge 136 of the main body. In some examples, the center front region 116 can be configured to provide little to no stretch, allowing for increased support and/or lockout.

Referring to FIG. 5, the garment comprises a plurality of struts defining a plurality of open cells 120 that make up the garment 100. The cells 120 can be oriented in different directions depending on the desired amount and direction of stretch. For example, the cells 120 of the main body 102 can have a substantially square or rectangular shape. This can also be referred to as a diamond shape depending on the orientation of the cell relative to the top edge 140 of the main body 102. The “square” orientation, wherein a strut of the cell is aligned with (i.e., substantially parallel to) the uppermost edge 148 of the garment, provides less stretch, while the “diamond” orientation, wherein an apex of the cell (i.e., the place where two struts meet) is oriented toward the uppermost edge 148 of the garment, provides greater stretch. Cells can be rotationally oriented in any position between square and diamond depending on the desired amount of stretch.

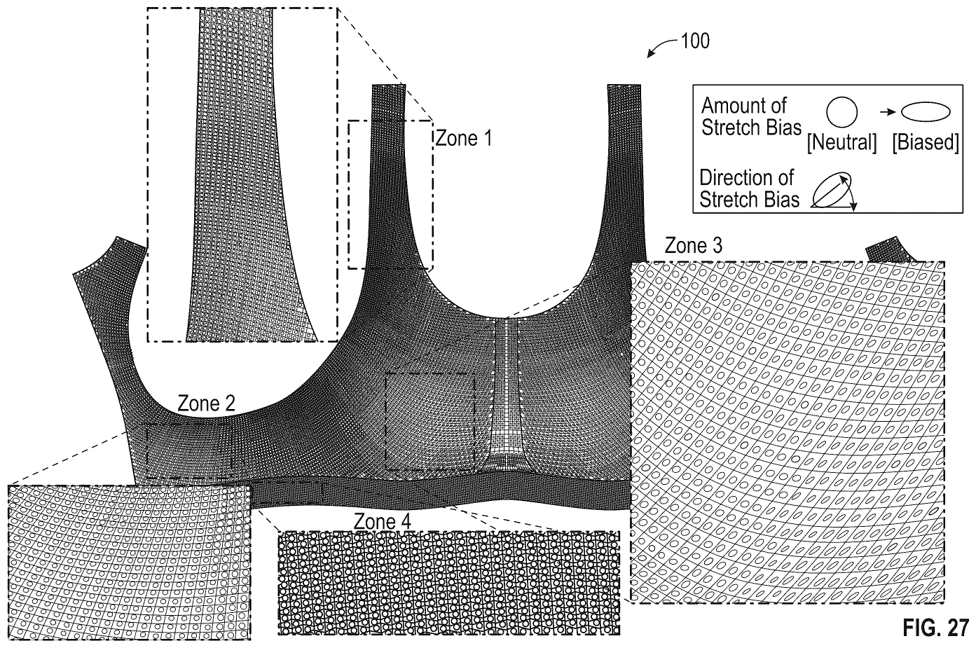

FIG. 27 shows the garment 100 with the cells 120 shown in an enlarged view for different zones 1-4 corresponding to the strap region 112 (zone 1), the side region 130 (zone 2), the cup region 106 (zone 3), and the band region 104 (zone 4). For purposes of illustration only, the cells 120 in FIG. 27 include a shape (e.g., a circle or oval) disposed within the cell that indicates the amount and direction of stretch for that cell when the garment 100 is in the relaxed configuration. It should be understood that the shapes are for purposes of illustration only and do not exist in the final garment.

As shown, the cells in zones 1 and 2 are generally neutral when the garment is in the relaxed configuration, while the cells in zone 3 include some stretch bias even when in the relaxed configuration. This configuration allows for increased stretch in zone 3, and increased support in zones 1 and 2.

Call-outs A and B in FIG. 5 illustrate the orientation of the cells in the strap region 112 and cup region 106, respectively. As shown in call-out A, the cells 120 in the strap region 112 are oriented in a “square” direction. As shown in call-out B, the cells 120 in the cup region 106 are oriented in a “diamond” direction or, in other words, each cell 120 is on a bias relative to the uppermost edge 148 of the garment. Referring to call-out C, the cells 120 of the center front region 116 are positioned in a square orientation, though the lower portion 142 of the center front region 116 has increased cell density (i.e., the number of cells per square inch). This increased cell density provides additional support (e.g., decreased stretch) at the lower portion 142.

Referring still to FIG. 5, selected areas of the garment can have differing cell densities. Higher cell density provides additional support by reducing the amount of stretch in selected areas. Areas of greater cell density can have smaller cells to provide such density. For example, call-outs D, E, and F in FIG. 5 indicate areas of higher cell density in the upper cup region 124 (call-out D), the underarm region 125 (call-out E), and the second lower cup region 128 (call-out F). Though only one upper cup region 124, underarm region 125, and second lower cup region 128 are indicated in FIG. 5, it should be understood that, since the garment is bilaterally symmetrical, the cell density is mirrored on both sides. Less stretch along the underarm region 125 allows the arm hole 144 to fit snugly against the wearer's body without gapping. Less stretch along the upper cup region 124 mitigates upward movement of the wearer's breasts during movement, which can be painful or distracting for the wearer. Less stretch along the second lower cup region helps lift and support the wearer's breasts during movement.

As mentioned previously, the band region 104 comprises an auxetic pattern configured to allow the band region 104 to avoid vertical collapse (i.e., narrowing) when stretched horizontally. Auxetic patterns have a negative Poisson's ratio, meaning that when they are stretched, they become thicker perpendicularly to the applied force. Call-out G in FIG. 5 shows one example of an auxetic pattern in the band region 104.

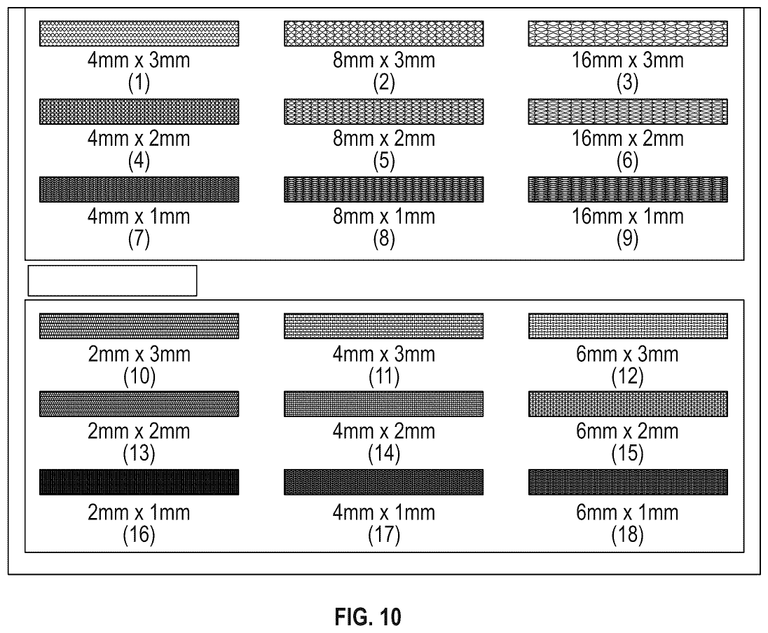

FIG. 10 illustrates various auxetic patterns numbered (1) through (18). In some examples, the band region 104 can comprise one or more of the auxetic patterns shown in FIG. 10. In other examples, the band region 104 can comprise any other auxetic pattern that prevents the band region 104 from narrowing when stretched horizontally. Referring to FIG. 10, the dimensions below each pattern refer to the height and width of each cell when the material is in the relaxed configuration. For example, pattern (1) includes cells that are 4 mm high by 3 mm wide when in the relaxed configuration and pattern (14) includes cells that are 4 mm high by 2 mm wide when in the relaxed configuration. Each auxetic pattern includes a plurality of cells arranged such that, when they are stretched, the cells become thicker perpendicularly to the applied force. For example, pattern (1) includes a plurality of diamond-shaped cells in combination with a variety of bowtie-shaped cells (also referred to herein as butterfly-shaped). Patterns (10) through (18) each include a plurality of bowtie-shaped cells arranged such that the rows are offset from one another to form an interlocking pattern.

In some examples (e.g., as shown in FIG. 26), the auxetic pattern can include a plurality of bowtie-shaped cells that have a width, a first height at the first and second ends of the cell 125, 127, and a second height at the center of the cell 129, which is less than the first height. When in the relaxed configuration, the smallest cells of the auxetic pattern have a minimum width W₃ of between about 2.0 mm to about 4.0 mm, of about 2.5 mm to about 3.5 mm, of about 2.8 mm to about 3.2 mm. When in the relaxed configuration, the smallest cells of the auxetic pattern have a minimum first height H₃ of between about 1.4 mm to about 2.2 mm, of about 1.6 mm to about 2.0 mm, of about 1.7 mm to about 1.9 mm. When in the relaxed configuration, the smallest cells of the auxetic pattern have a minimum second height H₄ of between about 0.2 mm to about 1.0 mm, of about 0.4 mm to about 0.8 mm, of about 0.5 mm to about 0.7 mm.

In some examples (e.g., as shown in FIG. 26), when in the relaxed configuration, the largest cells of the auxetic pattern have a minimum width W₄ of between about 4.2 mm to about 5.0 mm, of about 4.4 mm to about 4.8 mm, of about 4.5 mm to about 4.7 mm. When in the relaxed configuration, the largest cells of the auxetic pattern have a minimum first height H₅ of between about 1.4 mm to about 2.2 mm, of about 1.6 mm to about 2.0 mm, of about 1.7 mm to about 1.9 mm. When in the relaxed configuration, the largest cells of the auxetic pattern have a minimum second height H₆ of between about 0.2 mm to about 1.0 mm, of about 0.4 mm to about 0.8 mm, of about 0.5 mm to about 0.7 mm.

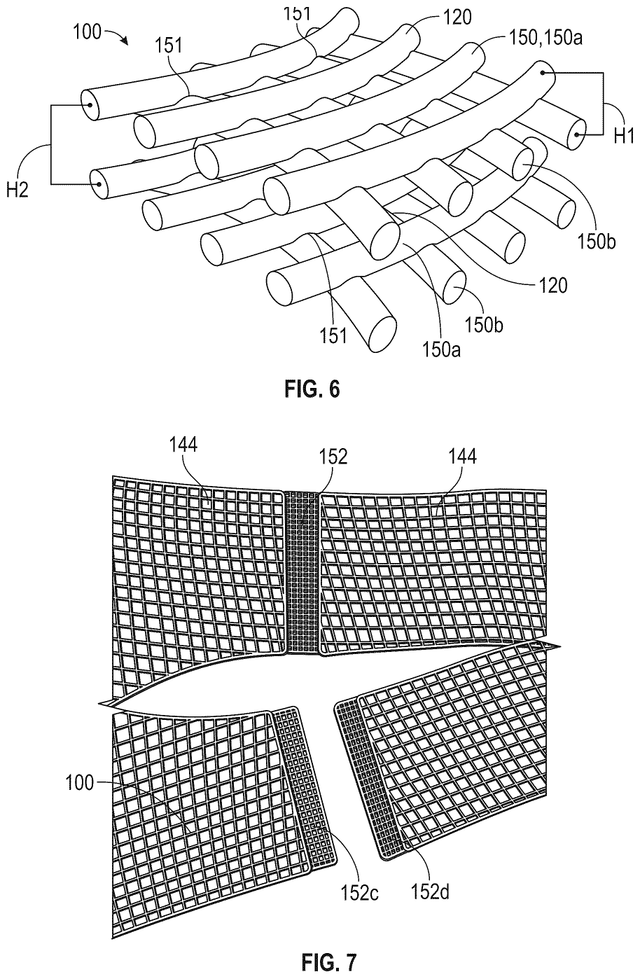

Referring now to FIG. 6, in some examples, the garment comprises a plurality of filament layers 150. The layers 150 can be arranged on top of one another such that the filaments of a first layer 150a extend in a different direction than the filaments of an adjacent second layer 150b. In the illustrated example, the garment 100 includes four filament layers 150, which include two first layers 150a extending in a first direction and two second layers 150b extending in a second direction different than the first direction. However, in other examples, the garment can comprise a greater or fewer number of filament layers, such as one, two, three, five, six, seven, eight, nine, or ten layers. Additional filament layers can be added to the garment to, for example, provide additional stretch and/or support in selected areas or provide increased durability in selected areas. In some examples, different filament layers can comprise different materials, which can be used to achieve different garment properties.

As shown in FIG. 6, the first and second layers 150a, 150b are disposed in an alternating pattern and overlap each other at a plurality of overlap points 151. The distance between a center point of each first filament layer 150a and a center point of each adjacent second filament layer 150b is referred to as H1. In some examples, H1 is about 0.1 mm. The distance between a center point of two adjacent first filament layers 150a and two adjacent second filament layers 150b is referred to as H2. In some examples, H2 is about 0.15 mm. Together, the filament layers 150a, 150b define the plurality of cells 120.

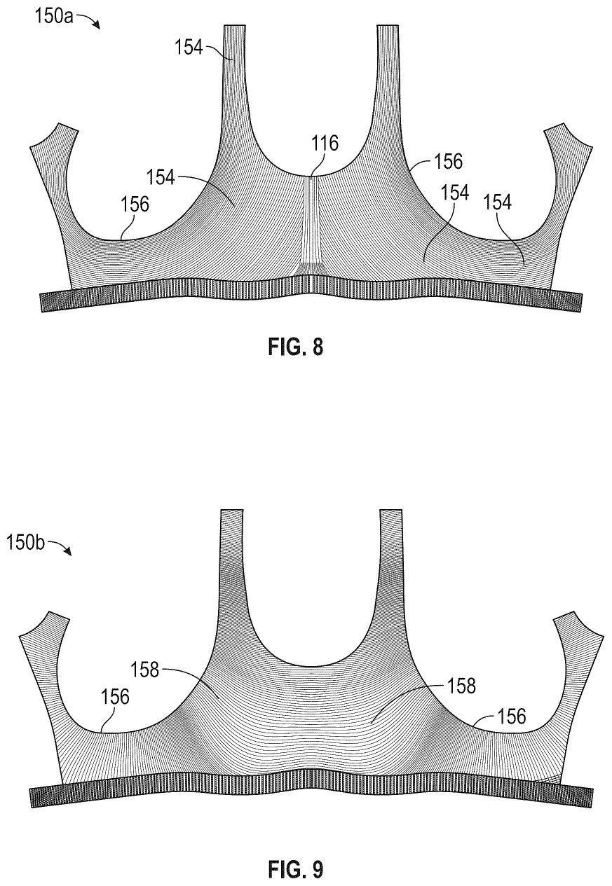

FIG. 8 illustrates the garment 100, showing only the first filament layers 150a, which, in a garment having four layers, can be, for example, the first and third layers. FIG. 9 illustrates the garment 100 showing only the second filament layers 150b, which, in a garment having four layers, can be, for example, the second and fourth layers. As shown in FIGS. 8-9, the filaments 150a extend in a different direction than the filaments 150b such that, when layered atop one another, they define the plurality of cells 120.

For example, referring to FIG. 8, the first filament layers 150a comprise a plurality of first filaments 154 that mimic the curvature of the armholes 156 and radiate from the armholes 156 toward the center front region 116. Referring to FIG. 9, the second filament layers 150b comprise a plurality of second filaments 158 that extend from the armholes 156 in a radial pattern.

Referring to FIG. 7, the garment 100 further comprises a plurality of coupling portions 152 (also referred to herein as “seam allowances”) that are used to couple portions of the garment together to form the garment into a three-dimensional structure. As shown in FIG. 7, the coupling portions 152 can be an extension of the garment pattern. In other words, they can be formed using the filament layers 150. Exemplary locations for the coupling portions 152 are shown in FIGS. 3-4. In some examples, the garment 100 can comprise six coupling portions 152, represented by reference numerals 152a-f. Coupling portions 152a, 152d, 152e, and 152f extend from the back region 110, and coupling portions 152b and 152c extend from the straps 114, respectively. Coupling portion 152a is configured to be coupled to coupling portion 152b, coupling portion 152c is configured to be coupled to coupling portion 152d, and coupling portion 152e is configured to be coupled to coupling portion 152f.

The coupling portions 152 can be coupled to one another using any known method. For example, the coupling portions 152 can be ultrasonically welded, fused together using a heat press, sewn together, and/or joined together using fasteners (e.g., buttons, hook and eye closures, snaps, etc.).

In some examples, the garment 100 is formed using a 3D printer to print the filament layers 150 one on top of the other. In such examples, the garment 100 can be printed as a two-dimensional unitary or continuous garment, which can then be assembled into a three-dimensional garment using the coupling portions 152. In other examples, the garment 100 can be formed using molding.

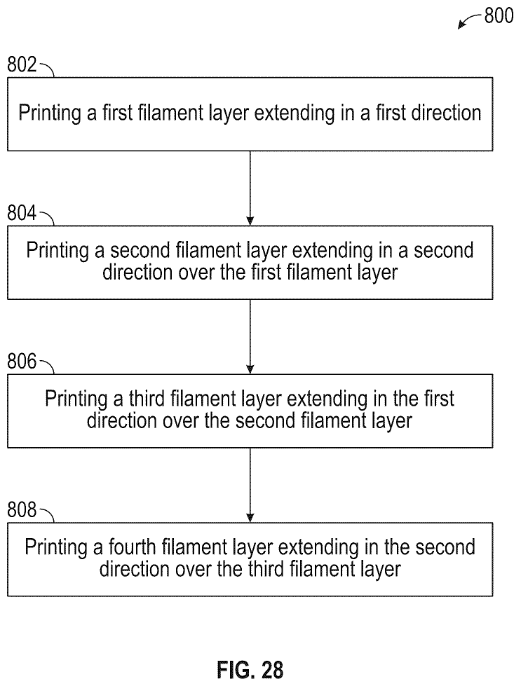

An exemplary method 800 of forming the garment 100 is shown in FIG. 28 and can proceed as follows. In step 802, a first filament layer 150a is printed extending in a first direction. In step 804, a second filament layer 150b is printed extending in a second direction over the first filament layer. The second filament layer 150b can overlap the first filament layer 150a at a plurality of first overlap points. In step 806, a third filament layer 150a is printed extending in the first direction over the second filament layer 150b. The third filament layer can overlap the second filament layer at a plurality of second overlap points. In step 808, a fourth filament layer 150b is printed extending in the second direction over the third filament layer 150a. The fourth filament layer 150b can overlap the third filament layer 150a at a plurality of third overlap points. The overlying and overlapping filament layers 150a, 150b form the various cell structures described herein.

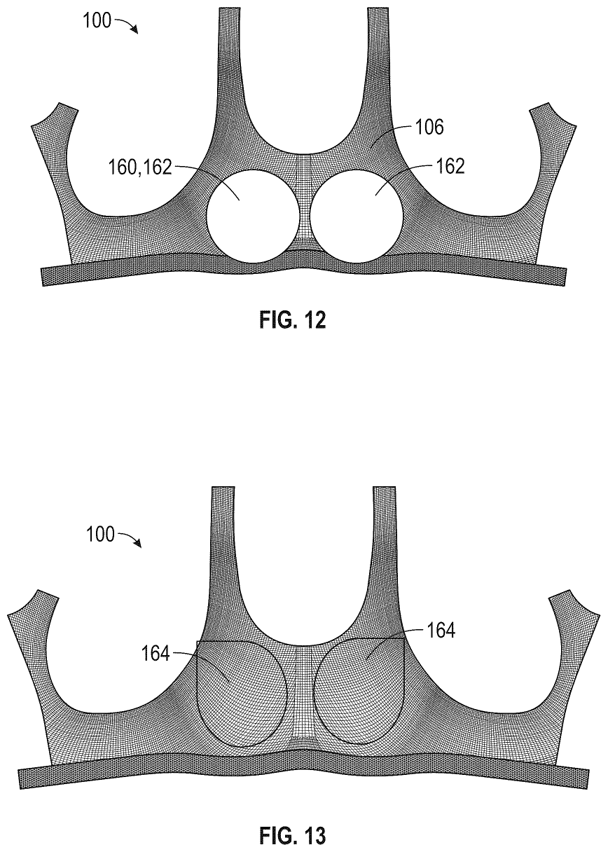

As previously described, the garment 100 comprises one or more additional layers. In some examples, the additional layers are additional layers of printed material oriented in a manner that creates areas of increased modesty. For example, multiple layers can be printed on top of one another in a “cross-hatched” configuration to create areas of increased opacity (e.g., to provide increased modesty in the cup region 106). In other examples, the additional layers can be one or more fabric layer(s) 160. The fabric layer 160 can extend over the entire area of the garment 100 or can be disposed in specific regions (e.g., for modesty and/or to prevent chafing). For example, FIG. 12 illustrates a garment 100 including a fabric layer 160 that comprises two modesty regions 162. In some examples, the fabric layer 160 can comprise a knit material that can be bonded and/or adhered to the cup region 106 or to each specific cup 108.

In some examples, the garment 100 comprises one or more pockets 164 configured to receive an insert (e.g., a modesty insert) and maintain it in a desired position. The pockets 164 can be formed, for example, by positioning a removable barrier in selected regions during deposition of the filament layers 150. After the layer deposition is finished, the removable barrier can be removed, leaving a pocket 164 between selected layers that is configured to receive an insert. The insert can be a fabric insert, such as a knit or woven material, or a 3D printed insert comprising the same 3D printed material as the garment 100. In some examples, the pockets 164 can be sealed after insertion of the insert. However, in other examples, the pockets 164 can be left open to allow the wearer to remove and/or replace the insert as desired.

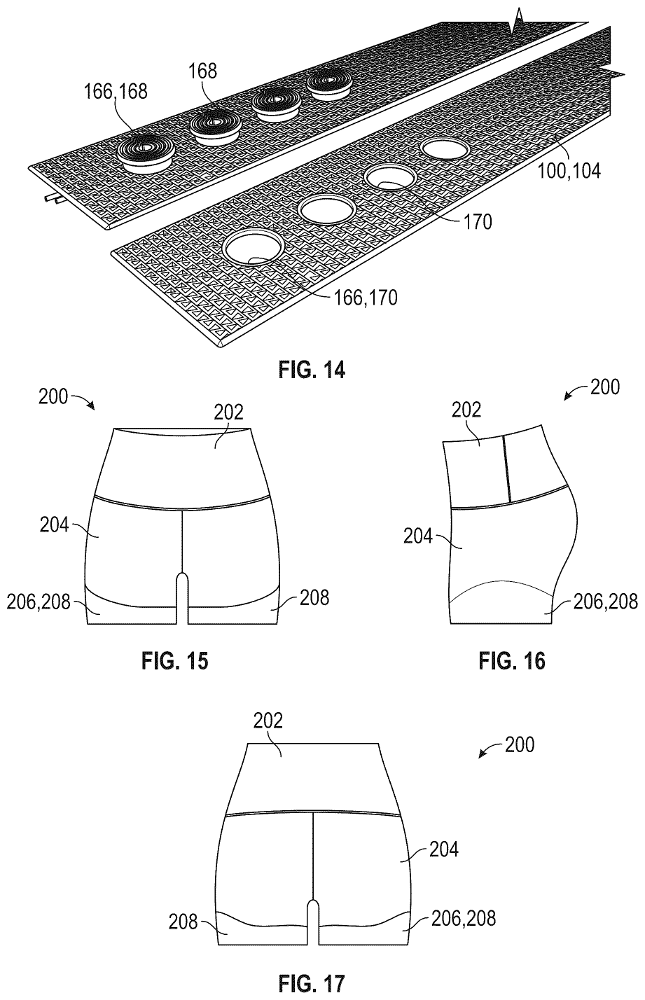

Referring to FIG. 14, in some examples, in lieu of or in addition to coupling portions 152, any of the garments described herein comprise one or more fasteners 166. In some examples, the fasteners 166 can be formed integrally with the garment 100 (e.g., during the 3D printing process) and can, in some examples, comprise the same material as the garment 100. In other examples, the fasteners 166 can be separate structures permanently or removably coupled to the garment 100. In such examples, the fasteners can be formed from the same material as the garment 100 or can be formed from a different material.

The fasteners 166 can be used, for example, to form the garment into a three-dimensional structure and/or to allow the garment to be adjusted to different sizes. For example, the fasteners 166 can be located on the band region 104 and/or straps 114 to allow the length of the band region 104 and/or straps 114 to be adjusted by the wearer, as desired. As shown in FIG. 14, in some examples, the fasteners 166 can comprise one or more buttons 168 and one or more button holes 170 through which the one or more buttons can be inserted. In other examples, the fasteners can be lacing (e.g., corseting), hook and eye closures, zippers, snaps, buckles, hook and loop (e.g., Velcro).

FIGS. 15-17 illustrate an example of a lower body garment 200. In the illustrated example, the lower body garment 200 is a pair of shorts that includes a waistband region 202, a brief region 204, and a leg region 206 that includes two leg bands 208. Lower body garment 200 comprises a mesh, open cell material (similar to the mesh, open cell material described previously for garment 100). As described previously, the mesh material provides a range of potential benefits to the wearer, including increased breathability and sweat evaporation, improved fit and comfort, increased potential for sustainability and/or recyclability, and potential for greater customization. The shape, orientation, and density of the cells in particular regions of the lower body garment 200 can be selected based on the properties (e.g., a desired amount of stretch and/or support) desired in those regions.

In some examples, the lower body garment 200 comprises both the open cell material and a fabric material. For example, the waistband region 202 and the leg bands 208 can comprise the open cell material, and the brief region 204 can comprise the fabric material, such as a knit material. Such a configuration provides increased breathability and sweat efficiency at the waistband region 204 (which is a high heat/sweat region), while also providing a better contour and fit to the wearer's body than a traditional fabric material. The use of the open cell material to form the leg bands 208 helps hold the legs of the garment in place and prevents them from rolling or moving up the body. Whereas the fabric material at the brief region 204 provides an increased level of modesty. In other examples, the entire garment 200 can comprise the open cell material. In other examples still, portions of the garment 200 can optionally comprise additional fabric layers, such as fabric layer (160) described herein and shown in FIG. 12.

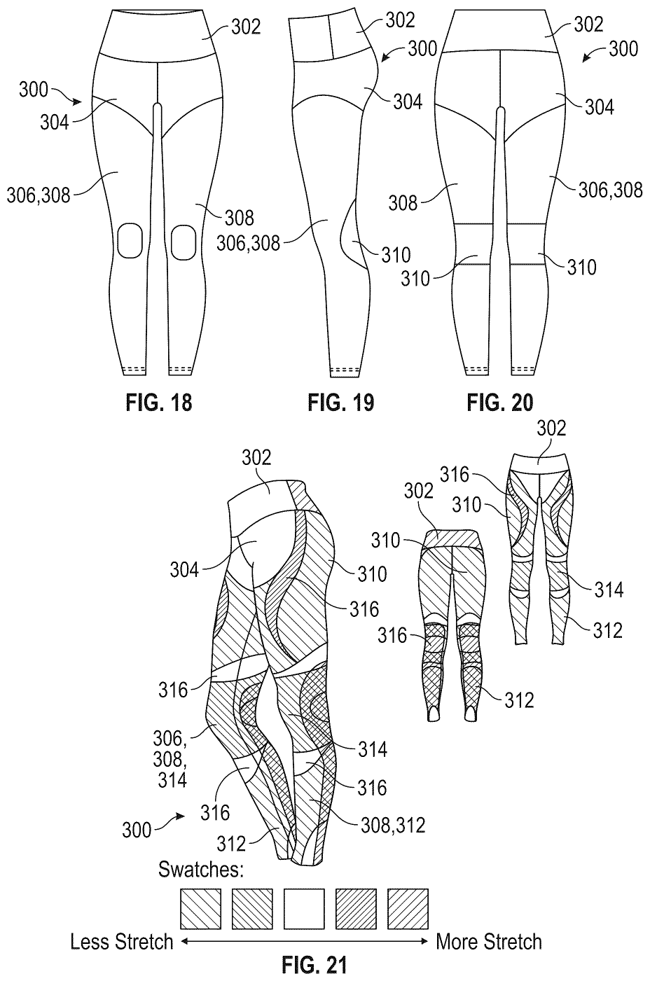

FIGS. 18-21 illustrate another example of a lower body garment 300. In the illustrated example, the lower body garment 300 is a pair of leggings that includes a waistband region 302, a brief region 304, and a leg region 306 that includes two leg members 308. As described herein with respect to lower body garment 200, lower body garment 300 also comprises a mesh, open cell material. The shape, orientation, and density of the cells in particular regions of the lower body garment 300 can be selected based on the properties (e.g., a desired amount of stretch and/or support) desired in those regions.

In some examples, the waistband region 302 and the leg members 308 comprises the open cell material, and the brief region 304 comprises the fabric material. Portions of the waistband 302 and leg members 308 can be configured (e.g., the cells can be sized, shaped, oriented, and provided in a specific density) to provide different properties. For example, waistband 304 and the region behind the knee 310, which are both high heat and sweat producing areas, can be configured to provide increased breathability.

Referring to FIG. 21, in some examples, selected regions can be configured to provide support and/or compression (e.g., by having a higher modulus of elasticity, which allows for less stress), while other selected regions are configured to provide increased stretch (e.g., by having a lower modulus of elasticity). For example, the thigh/butt region 310 and the shin region 312 can be configured to provide support/compression, and the knee region 314 can be configured to provide increased stretch. In another example, a front portion of the waistband region 302 can provide more support (e.g., less stretch) than a back portion of the waistband region 302.

As shown in FIG, 21, in some examples, the garment 300 can comprise one or more patterned regions 316 that can be designed to provide areas of more or less support. For example, the garment 300 can comprise patterned regions 316 along the thigh portion of the leg members 308, above and below the knee region 314, on the back of the knee region 314, and/or adjacent the wearer's ankles. In some examples, the patterned regions 316 can be configured to provide additional stretch. In other examples, patterned regions 316 can be configured to provide additional support.

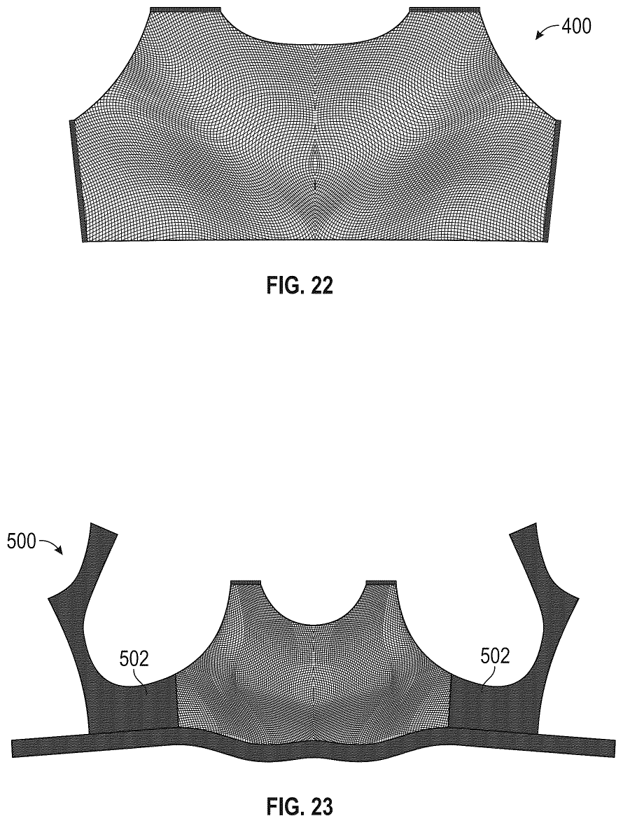

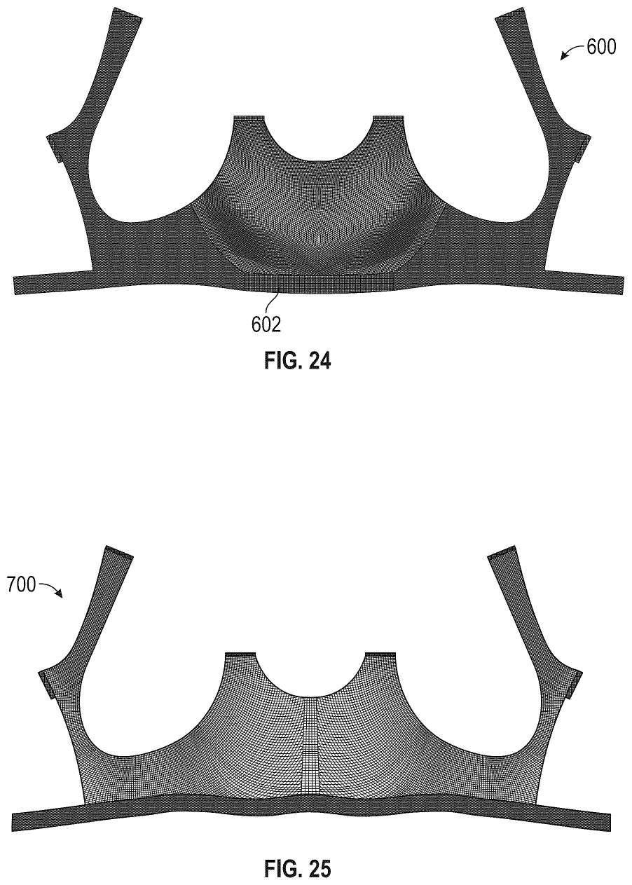

FIGS. 1-13 illustrate one example of a garment 100 with selected regions of stretch and support defined by cell orientation, cell density, and cell pattern. However, it should be understood that the cell orientations, cell densities, and cell patterns can be modified and re-arranged to provide the selected amounts of stretch and support. For example, FIGS. 22-25 illustrate exemplary garments 400, 500, 600, and 700 having different cell orientations, regions of stretch, support regions, etc. Darker regions indicate regions of increased cell density and/or regions having auxetic patterns. For example, FIG. 23 illustrates a garment 500 having increased cell density in the side and back region 502 which can result in additional back support. FIG. 24 illustrates a garment 600 having a shortened band region 602.

In view of the above-described implementations of the disclosed subject matter, this application discloses the additional examples enumerated below. It should be noted that one feature of an example in isolation or more than one feature of the example taken in combination and, optionally, in combination with one or more features of one or more further examples are further examples also falling within the disclosure of this application.

Example 1. A support garment comprising: a material comprising a plurality of regions, each region comprising a plurality of open cells arranged in a pattern, wherein each cell of the plurality of open cells has a minimum width of 1.8 mm and a minimum height of 1.2 mm and a maximum width of 3.5 mm and a maximum height of 5.1 mm when the support garment is in a relaxed configuration.

Example 2. The garment of any example herein, particularly Example 1, wherein the plurality of regions comprises a band region configured to be disposed around a wearer's ribcage, and wherein the plurality of open cells in the band region comprises an auxetic pattern.

Example 3. The garment of any example herein, particularly any one of Examples 1-2, wherein each cell of the plurality of open cells comprising the auxetic pattern has a bowtie shape.

Example 4. The garment of any example herein, particularly Example 3, wherein each cell having a bowtie shape has a width, a first height at a first and a second end portion of the cell, and a second height at a center portion of the cell, the second height being less than the first height.

Example 5. The garment of any example herein, particularly Example 4, wherein each cell comprising the auxetic pattern has a minimum width of 3.0 mm, a minimum first height of 1.8 mm, and a minimum second height of 0.6 mm when in the relaxed configuration.

Example 6. The garment of any example herein, particularly Example 1, wherein the material has a homogenous composition.

Example 7. The garment of any example herein, particularly Example 1, wherein the material comprises thermoplastic polyurethane (TPU).

Example 8. A support garment comprising: a plurality of open cells, the plurality of open cells being arranged in one or more patterns to form one or more regions; wherein each region comprises a selected modulus of elasticity; and wherein at least one region of the one or more regions is a first region comprising an auxetic pattern.

Example 9. The support garment of any example herein, particularly Example 8, wherein the first region is a band region configured to be disposed around a wearer's ribcage.

Example 10. The support garment of any example herein, particularly Example 8, wherein each of the cells in the first region has a bow-tie shape.

Example 11. The support garment of any example herein, particularly any one of Examples 8-10, wherein the support garment is a unitary piece of material.

Example 12. The garment of any example herein, particularly any one of Examples 8-11, wherein the one or more regions further comprise a second region configured to be disposed over a wearer's breastbone, and wherein each of the cells in the second region is positioned in a square orientation.

Example 13. The garment of any example herein, particularly any one of Examples 8-12, wherein the one or more regions comprise a third region configured as a cup region, and wherein the plurality of cells that make up the cup region have a modulus of elasticity that is less than the modulus of elasticity of the cells that make up the second region.

Example 14. The garment of any example herein, particularly Example 13, wherein the one or more regions comprise a fourth region configured as a strap region, and wherein the plurality of cells that make up the strap region have a modulus of elasticity that is greater than the modulus of elasticity of the cells that make up the third region.

Example 15. The garment of any example herein, particularly any one of Examples 8-14, wherein the one or more regions further comprise a third region configured as a cup region, and wherein the cup region comprises one or more integrated pockets configured to accept one or more modesty inserts.

Example 16. The garment of any example herein, particularly any one of Examples 7-14, wherein the material comprises thermoplastic polyurethane (TPU).

Example 17. An upper body garment comprising: a material comprising a plurality of open cells, the plurality of open cells arranged in one or more patterns to form a breast cup region, a center front region, a band region, and a strap region, each region having a different modulus of elasticity; wherein the breast cup region comprises a first breast cup portion and a second breast cup portion; wherein the center front region is disposed between the first breast cup portion and the second breast cup portion; wherein the band region is configured to extend around a wearer's ribcage; and wherein the strap region comprises a first strap portion and a second strap portion.

Example 18. The upper body garment of any example herein, particularly Example 16, wherein the band region comprises a structure having a negative Poisson's ratio.

Example 19. The upper body garment of any example herein, particularly any one of Examples 17-18, wherein the breast cup region, center front region, band region, and strap region each comprise a different cell density.

Example 20. The upper body garment of any example herein, particularly any one of Examples 17-19, wherein the modulus of elasticity of the breast cup region is less than the modulus of elasticity of each of the center front, band, and strap regions.

Example 21. A method comprising: 3D printing a garment comprising: a material including a plurality of open cells, the plurality of open cells arranged in one or more patterns to form first, second, third, and fourth regions, each region having a modulus of elasticity different from the modulus of elasticity of each of the other regions, the first region being configured as a cup region comprising a first cup portion and a second cup portion, the second region being disposed between the first cup portion and the second cup portion, the third region being configured as a band region configured to extend around a wearer's ribcage, and the fourth region being configured as a strap region comprising a first strap portion and a second strap portion.

Example 22. The method of any example herein, particularly Example 21, wherein 3D printing the garment includes printing a first filament layer extending in a first direction and printing a second filament layer over the first filament layer, the second filament layer extending in a second direction different from the first direction such that the first and second filament layers overlap one another at a plurality of overlap points.

Example 23. The method of any example herein, particularly Example 22, further comprising printing a third filament layer over the second filament layer, the third filament layer extending in the first direction.

Example 24. The method of any example herein, particularly Example 23, further comprising printing a fourth filament layer over the third filament layer, the fourth filament layer extending in the second direction.

Example 25. A method of 3D printing a garment comprising: 3D printing a first filament layer extending in a first direction; and 3D printing a second filament layer over the first filament layer, the second filament layer extending in a second direction different than the first direction such that the first and second filament layers overlap one another at a plurality of contact points and collectively define a plurality of open cells.

Example 26. The method of any example herein, particularly example 25, further comprising printing a third filament layer over the second filament layer, the third filament layer extending in the first direction.

Example 27. The method of any example herein, particularly any one of examples 25-26, further comprising printing a fourth filament layer over the third filament layer, the fourth filament layer extending in the second direction.

Example 28. The method of any example herein, particularly any one of examples 25-27, wherein each cell of the plurality of open cells has a minimum width of 1.8 mm and a minimum height of 1.2 mm and a maximum width of 3.5 mm and a maximum height of 5.1 mm when the garment is in a relaxed configuration.

Example 29. The method of any example herein, particularly any one of examples 25-28, further comprising 3D printing a band region of the garment comprising an auxetic pattern.

Example 30. The method of any example herein, particularly examples 29, wherein the auxetic pattern comprises a plurality of cells each comprising a bowtie shape.

Example 31. The method of any example herein, particularly any one of examples claims 25-30, wherein one or more filament layers comprise thermoplastic polyurethane (TPU).

Example 32. The method of any example herein, particularly any one of examples 25-31, further comprising 3D printing a plurality of coupling portions, wherein each coupling portion is configured to be coupled to one or more additional coupling portions to form the garment into a three-dimensional structure.

Example 33. The method of any example herein, particularly example 32, further comprising coupling each coupling portion to the one or more additional coupling portions using ultrasonic welding.

Example 34. The method of any example herein, particularly example 32, further coupling each coupling portion to the one or more additional coupling portions using a heat press.

Example 35. A method of 3D printing a garment comprising: 3D printing a first filament layer extending in a first direction; and 3D printing a second filament layer over the first filament layer, the second filament layer extending in a second direction different than the first direction such that the first and second layers overlap one another at a plurality of contact points and collectively define a plurality of open cells forming a main body of the garment, wherein the plurality of open cells are arranged in one or more patterns to form a plurality of regions, each region having a modulus of elasticity different from the modulus of elasticity of each of the other regions; 3D printing a third filament layer over the second filament layer, the third filament layer extending in the first direction; 3D printing a fourth filament layer over the third filament layer, the fourth filament layer extending in the second direction; 3D printing a plurality of coupling portions coupled to the main body; and coupling each coupling portion of the plurality of coupling portions to one or more other coupling portions to form the garment into a three-dimensional structure.

Example 36. The method of any example herein, particularly any one of examples 35, wherein the plurality of regions comprises first, second, third, and fourth regions, the first region being configured as a cup region comprising a first cup portion and a second cup portion, the second region being disposed between the first cup portion and the second cup portion, the third region being configured as a band region configured to extend around a wearer's ribcage, and the fourth region being configured as a strap region comprising a first strap portion and a second strap portion.

Example 37. The method of any example herein, particularly example 36, wherein the band region comprises a structure having a negative Poisson's ratio.

Example 38. The method of any example herein, particularly any one of examples 35-37, further comprising 3D printing one or more additional modesty layers in selected regions of the garment, the modesty layers configured to increase opacity of the garment in the selected region.

Example 39. The method of any example herein, particularly any one of examples 35-38, further comprising 3D printing one or more pockets onto the garment.

Example 40. The method of any example herein, particularly any one of examples 35-39, wherein the coupling portions comprise a plurality of fasteners which are 3D printed as part of the garment.

Example 41. The method of any example herein, particularly any one of examples 35-40, wherein a distance between a center point of two adjacent first filament layers is 0.1 mm and a distance between a center point of two adjacent second filament layers is 0.1 mm.

Example 42. The method of any example herein, particularly any one of examples 35-41, further comprising coupling one or more fabric layers to the garment.

Example 43. A garment formed by a method comprising: 3D printing a first filament layer extending in a first direction; and 3D printing a second filament layer over the first filament layer, the second filament layer extending in a second direction different than the first direction such that the first and second layers overlap one another at a plurality of contact points and collectively define a plurality of open cells forming a main body of the garment, wherein the plurality of open cells are arranged in one or more patterns to form a plurality of regions, each region having a modulus of elasticity different from the modulus of elasticity of each of the other regions; 3D printing a third filament layer over the second filament layer, the third filament layer extending in the first direction; 3D printing a fourth filament layer over the third filament layer, the fourth filament layer extending in the second direction; wherein the plurality of regions comprise first, second, third, and fourth regions, the first region being configured as a cup region comprising a first cup portion and a second cup portion, the second region being disposed between the first cup portion and the second cup portion, the third region being configured as a band region configured to extend around a wearer's ribcage, and the fourth region being configured as a strap region comprising a first strap portion and a second strap portion.

Example 44. The garment of any example herein, particularly example 43, wherein each cell of the plurality of open cells has a minimum width of 1.8 mm and a minimum height of 1.2 mm and a maximum width of 3.5 mm and a maximum height of 5.1 mm when the garment is in a relaxed configuration.

Example 45. A garment formed by a method comprising: molding the garment, wherein the garment comprises a plurality of regions, each region comprising a plurality of open cells arranged in a pattern, wherein each cell of the plurality of open cells has a minimum width of 1.8 mm and a minimum height of 1.2 mm and a maximum width of 3.5 mm and a maximum height of 5.1 mm when the support garment is in a relaxed configuration.

Example 46. The garment of any example herein, particularly Example 45, wherein the plurality of regions comprise first, second, third, and fourth regions, the first region being configured as a cup region comprising a first cup portion and a second cup portion, the second region being disposed between the first cup portion and the second cup portion, the third region being configured as a band region configured to extend around a wearer's ribcage, and the fourth region being configured as a strap region comprising a first strap portion and a second strap portion.

Example 47. The garment of any example herein, particularly any one of Examples 45-46, wherein the cells in the band region comprise an auxetic pattern.

Example 48. The garment of any example herein, particularly any one of Examples 45-47, wherein each cell of the plurality of open cells comprising the auxetic pattern has a bowtie shape.

Example 49. A garment formed by a method comprising: molding the garment; wherein the garment comprises a plurality of regions including comprise first, second, third, and fourth regions, the first region being configured as a cup region comprising a first cup portion and a second cup portion, the second region being disposed between the first cup portion and the second cup portion, the third region being configured as a band region configured to extend around a wearer's ribcage, and the fourth region being configured as a strap region comprising a first strap portion and a second strap portion; and wherein the band region comprises an auxetic pattern.

Example 50. The garment of any example herein, particularly Example 49, wherein each cell of the plurality of open cells comprising the auxetic pattern has a bowtie shape.

Example 51. The garment of any example herein, particularly any one of Examples 49-50, wherein each cell having a bowtie shape has a width, a first height at a first and a second end portion of the cell, and a second height at a center portion of the cell, the second height being less than the first height.

Example 52. The garment of any example herein, particularly any one of Examples 49-51, wherein each cell comprising the auxetic pattern has a minimum width of 3.0 mm, a minimum first height of 1.8 mm, and a minimum second height of 0.6 mm when in the relaxed configuration.

In view of the many possible ways in which the principles of the disclosure may be applied, it should be recognized that the illustrated configurations depict examples of the disclosed technology and should not be taken as limiting the scope of the disclosure nor the claims. Rather, the scope of the claimed subject matter is defined by the following claims and their equivalents.

We claim:

1. A method of 3D printing a garment comprising:
3D printing a first filament layer extending in a first direction; and
3D printing a second filament layer over the first filament layer, the second filament layer extending in a second direction different than the first direction such that the first and second filament layers overlap one another at a plurality of contact points and collectively define a plurality of open cells.

2. The method of claim 1, further comprising printing a third filament layer over the second filament layer, the third filament layer extending in the first direction.

3. The method of claim 1, further comprising printing a fourth filament layer over the third filament layer, the fourth filament layer extending in the second direction.

4. The method of claim 1, wherein each cell of the plurality of open cells has a minimum width of 1.8 mm and a minimum height of 1.2 mm and a maximum width of 3.5 mm and a maximum height of 5.1 mm when the garment is in a relaxed configuration.

5. The method of claim 1, further comprising 3D printing a band region of the garment comprising an auxetic pattern.

6. The method of claim 5, wherein the auxetic pattern comprises a plurality of cells each comprising a bowtie shape.

7. The method of claim 1, wherein one or more filament layers comprise thermoplastic polyurethane (TPU).

8. The method of claim 1, further comprising 3D printing a plurality of coupling portions, wherein each coupling portion is configured to be coupled to one or more additional coupling portions to form the garment into a three-dimensional structure.

9. The method of claim 8, further comprising coupling each coupling portion to the one or more additional coupling portions using ultrasonic welding.

10. The method of claim 8, further coupling each coupling portion to the one or more additional coupling portions using a heat press.

11. A method of 3D printing a garment comprising:
3D printing a first filament layer extending in a first direction; and
3D printing a second filament layer over the first filament layer, the second filament layer extending in a second direction different than the first direction such that the first and second layers overlap one another at a plurality of contact points and collectively define a plurality of open cells forming a main body of the garment, wherein the plurality of open cells are arranged in one or more patterns to form a plurality of regions, each region having a modulus of elasticity different from the modulus of elasticity of each of the other regions;
3D printing a third filament layer over the second filament layer, the third filament layer extending in the first direction;
3D printing a fourth filament layer over the third filament layer, the fourth filament layer extending in the second direction;
3D printing a plurality of coupling portions coupled to the main body; and
coupling each coupling portion of the plurality of coupling portions to one or more other coupling portions to form the garment into a three-dimensional structure.

12. The method of claim 11, wherein the plurality of regions comprises first, second, third, and fourth regions, the first region being configured as a cup region comprising a first cup portion and a second cup portion, the second region being disposed between the first cup portion and the second cup portion, the third region being configured as a band region configured to extend around a wearer's ribcage, and the fourth region being configured as a strap region comprising a first strap portion and a second strap portion.

13. The method of claim 12, wherein the band region comprises a structure having a negative Poisson's ratio.

14. The method of claim 11, further comprising 3D printing one or more additional modesty layers in selected regions of the garment, the modesty layers configured to increase opacity of the garment in the selected region.

15. The method of claim 11, further comprising 3D printing one or more pockets onto the garment.

16. The method of claim 11, wherein the coupling portions comprise a plurality of fasteners which are 3D printed as part of the garment.

17. The method of claim 11, wherein a distance between a center point of two adjacent first filament layers is 0.1 mm and a distance between a center point of two adjacent second filament layers is 0.1 mm.

18. The method of claim 11, further comprising coupling one or more fabric layers to the garment.

19. A garment formed by a method comprising:
3D printing a first filament layer extending in a first direction; and
3D printing a second filament layer over the first filament layer, the second filament layer extending in a second direction different than the first direction such that the first and second layers overlap one another at a plurality of contact points and collectively define a plurality of open cells forming a main body of the garment, wherein the plurality of open cells are arranged in one or more patterns to form a plurality of regions, each region having a modulus of elasticity different from the modulus of elasticity of each of the other regions;
3D printing a third filament layer over the second filament layer, the third filament layer extending in the first direction;
3D printing a fourth filament layer over the third filament layer, the fourth filament layer extending in the second direction;
wherein the plurality of regions comprise first, second, third, and fourth regions, the first region being configured as a cup region comprising a first cup portion and a second cup portion, the second region being disposed between the first cup portion and the second cup portion, the third region being configured as a band region configured to extend around a wearer's ribcage, and the fourth region being configured as a strap region comprising a first strap portion and a second strap portion.

20. The garment of claim 19, wherein each cell of the plurality of open cells has a minimum width of 1.8 mm and a minimum height of 1.2 mm and a maximum width of 3.5 mm and a maximum height of 5.1 mm when the garment is in a relaxed configuration.
